(19) United States
(12) Patent Application Publication
(10) Pub. No.: US 2005/0238341 A1
(43) Pub. Date: Oct. 27, 2005

(54) Baby formula preparation device

(76) Inventors: Yoav Thaler, Brooklyn, NY (US); Michelle H. Thaler, Brooklyn, NY (US)

Correspondence Address: Yoav Thaler, Apt 10J, 195 Adams Street, Brooklyn, NY, 11201, US

(21) Appl. No.: 10/821,506

(22) Filed: Apr. 9, 2004

(51) Int. Cl. A61J 9/00

(52) U.S. Cl. 392/441

(57) ABSTRACT

An apparatus for quickly and easily preparing a bottle of infant formula from powdered formula and water. The device warms the water contained in a baby bottle placed therein to a temperature substantially in a range around body temperature and keeps the water warmed to that temperature. The device further contains a dispensing mechanism allowing the quick and accurate dispensing of the required amount of formula into the baby bottle. Such apparatus succeeds in substantially reducing the time and effort associated with baby formula preparation. This device would be ideal for late night situations so the user is not required to partake in multiple time consuming tasks to prepare a baby bottle.

### SUMMARY OF THE INVENTION

The present invention addresses the need for reducing the time and effort required for preparing baby formula while keeping the solution simple, low-cost and easy to clean. The invention obviates the time-consuming need to actively measure baby formula, separately heat water and manually pour the pre-measured formula into a baby bottle (12). This invention is especially suited for the convenience of late night feedings. Further clean up is reduced or alternatively delayed until the invention dispenses all servings of baby formula. Additionally, the user no longer needs to be concerned with manually heating and checking the temperature of the water. The temperature of the formula can also be kept consistent at every feeding. Additionally, powdered formula mixes more efficiently in warm water.

### BRIEF DESCRIPTION OF THE DRAWINGS

Objects and features of the invention will be more clearly understood from the following detailed description along with the accompanying drawing figures, wherein:

FIG. 1 is a perspective view of an embodiment of the invention;

FIG. 2 is a side elevational view of the an embodiment of the invention;

FIG. 2a is a side elevational view of the an embodiment of the invention with the arm extended allowing removal of the baby bottle;

FIG. 3 is a partial diagrammatic view of an embodiment of a locking mechanism;

FIG. 3a is a partial perspective view of an embodiment of a locking mechanism arm;

FIG. 4 is a diagrammatic view of an embodiment of a dispensing mechanism;

FIG. 5 is a diagrammatic view of an embodiment of a heating mechanism;

FIG. 6 is a side elevational view of the an alternative embodiment of the invention;

FIG. 7 is a side elevational view of the alternative embodiment of the invention shown in FIG. 6 allowing removal of the baby bottle;

FIG. 8 is a side elevational view of another alternative embodiment of the invention;

FIG. 9 is a side elevational view of yet another alternative embodiment of the invention, and

FIG. 10 is a side elevational view of the alternative embodiment of the invention shown in FIG. 9 allowing removal of the baby bottle.

### DETAILED DESCRIPTION OF THE INVENTION

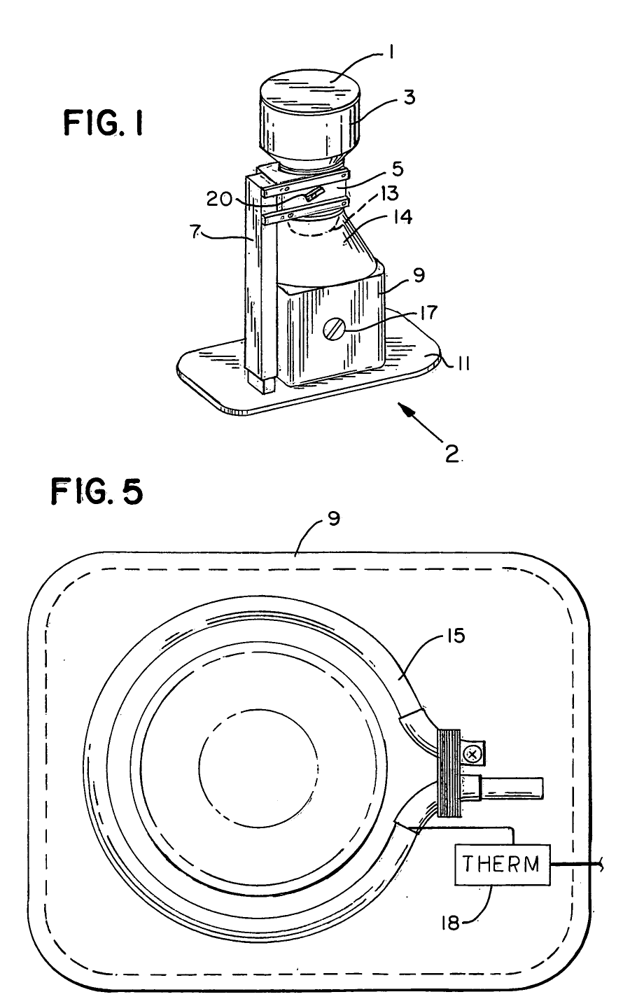

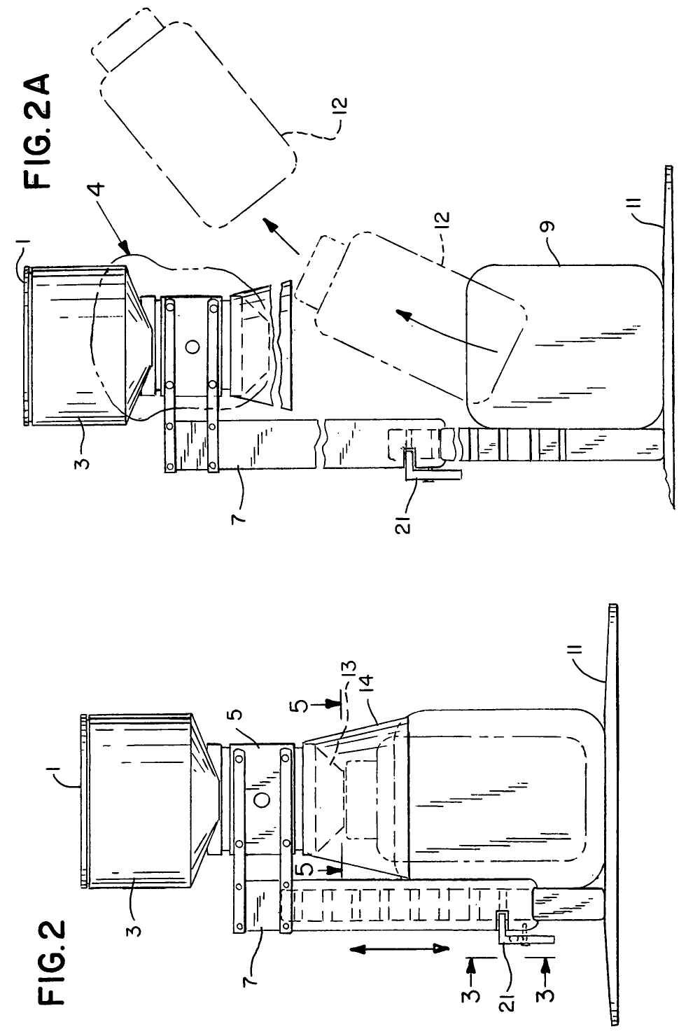

FIG. 1 displays the prospective diagram of an embodiment of the present invention which may have: a lid (1), formula reservoir (3), dispensing mechanism (5), handle (20), flange (13), cover (14), bottle housing (9), base (11), thermostat adjustment knob (17) and arm (7). One embodiment of the formula reservoir (3) holds eighteen ounces or more of formula, sufficient for at least several days of baby feedings. The capacity of the reservoir may be larger or smaller. Baby formula utilized for this invention may be any powder formula currently known in the art, available to the consuming public. Additionally a removable cover can seal the formula reservoir (3) which can take the form of a lid (1), removable for pouring formula into the formula reservoir (3). Furthermore the lid (1) may be air tight in order to keep the baby formula fresh. The formula reservoir (3) may be located immediately above the dispensing mechanism (5) forming a tight seal. An embodiment of the base (11) is to be shaped such that the invention remains stable in its operation. The base (11) can be of large area or weight to improve the stability of the invention. Immediately above the base (11) is the bottle housing (9). In one embodiment, the baby bottle (12), pre filled with water, is intended to be inserted within the bottle housing (9) for the operation of the invention, as shown in FIG. 2a. The bottle housing (9) can be made of an insulating material. Residing in the interior of the bottle housing (9) are one or more heating mechanism (s). The volume and depth of the bottle housing (9) can be adjusted through the use of inserts. The inserts can be of any shape to conform to the size of the bottle and bottle housing (9) and are made of a heat conducting material. The purpose of the inserts is to enable the shaped bottle to either be in better thermal conductivity with the heating mechanism or better receive the dispensed formula.

An arm (7) is connected to the bottle housing (9) with the opposed end of the arm (7) forming a detachable coupling to the dispensing mechanism (5) described below.

As shown in FIG. 4, the dispensing mechanism (5) in accordance with the present invention includes a wheel assembly having at least one dispensing member (19), a wheel casing partially surrounding the wheel, and two frame members attached to the wheel casing. The dispensing mechanism (5) may also contain a clock assembly. The wheel assembly is supported by an axle which is rotatably connected to the frame members and which allows the wheel assembly to rotate around a substantially horizontal axis. Alternatively, the wheel can rotate on a vertical axis. The dispensing member(s) (19) may be of fixed volume or of user adjustable volume in accordance to the serving size desirable. The baby formula within the dispensing member(s) is prevented from emptying during the rotation of the wheel between the load and unload positions by the wheel casing around the wheel. At the load and unload position there lie holes in the wheel casing.

A handle (20) is connected to the axle on the outside of one of the frame members, and is used to rotate the wheel assembly between the load and unload positions. On the frame member closest to the handle, there are located two protruding stubs (21a and 21b) which limit the rotational range of the handle. The user manually cranks the handle to a determined position defined by a stub to load the dispensing member (19), and then cranks the handle in the opposite direction to a position determined by the other stub to dispense at least one deposit of baby formula. A spring mechanism (25) may be utilized with the wheel to return the dispensing member (19) from the load to the unload position, or vice versa.

In another embodiment, a clock assembly is also supported by frame member and includes a motor mechanism, an adjustable clocking gear, and a bevel or spurs type wheel gear attached to axle. The clock assembly is designed to rotate the wheel assembly from the load position to the unload position and vice versa. The motor mechanism is of the continuous operation type and has a rotary output shaft. The motor mechanism can be of several types including a small electric motor powered by a dry-cell battery, or a mechanical wind-up motor energized by a key. In either case, the torque required of the output shaft is slight, resulting in a minimal power drain of the motor mechanism.

A flange (13) may be connected to the bottom of the dispensing mechanism (5) to better direct the flow of formula into the baby bottle (12) and prevent spillage. Furthermore, a cover (14), which could be conical in shape, may be connected to the bottom of the dispensing mechanism (5) to enclose the flange (13) and exposed part of the baby bottle (12), as shown in FIG. 2, thus improving thermal insulation and reducing spillage.

Alternative embodiments for the dispensing mechanism (5) are described in U.S. Pat. No. 1,728,526, U.S. Pat. No. 1,861,734, U.S. Pat. No. 2,259,710, U.S. Pat. No. 3,356,268, U.S. Pat. No. 4,162,751, U.S. Pat. No. 5,292,037, U.S. Pat. No. 5,947,336, U.S. Pat. No. 2,002,039, U.S. Pat. No. 2,088,836, U.S. Pat. No. 3,211,334, U.S. Pat. No. and 4,006,842, U.S. Pat. No. 6,189,742, which are incorporated herein by this reference.

Any type of baby bottle (12) may be used with this invention. The size or shape of the baby bottle (12) does not in any way limit its use with the invention. In one embodiment, multiple baby bottles (12) may be used with the invention. Each perspective baby bottle (12) can be seated in a carousel allowing immediate use. The user pre-fills the bottle with water prior placing the baby bottle (12) onto the bottle housing (9). Pre-boiled tap water is typically used. However, regular tap water, bottle water or purified water may also be used to fill the baby bottle (12). The invention can use a continuous warming mechanism, a flash warming mechanism, or a combination thereof. If a continuous heating mechanism is utilized, it will be used to heat the baby bottle (12) to a pre-determined temperature and keep it heated so that the baby bottle (12) is ready for immediate consumption once the formula is dispensed, a nipple put on and the bottle shaken.

As shown in FIG. 5, one embodiment of the heating mechanism is a heating weave (15) comprising a multiple of layers. The intermediate layer constitutes the heating element and is made of flexible material which consists of heating resistors. The internal layer, which covers that face of the heating element and which is to be placed in contact with the baby bottle (12), is constituted of heat-insulating material such as glass wool or any other suitable mineral fiber. The external layer is composed of a heat-resistant fabric to prevent the user from injury. The heating weave (15) may be flexible in order to facilitate any size baby bottle (12) to be used with the device. Alternatively, the heating weave (15) may have an opening such that the baby bottle (12) may be placed within the heating weave (15). Once the baby bottle (12) is placed within the heating weave (15), the weave can be wrapped around any size baby bottle (12) with a fastening mechanism. Such fastening mechanism may take the form of, but not limited to: a snap, Velcro, screw, zipper, adjustable clip, or magnetic closure.

Power to the heating mechanism is controlled by a thermostat to achieve the desired water temperature. The thermostat (18) may be user adjustable. Power can be delivered with an outlet AC current through plug, or with a 12V DC current through a step-down transformer or battery. An on/off switch, which turns power on and off to the heating element and thermostat (18), may be located on the base (11) or the bottle housing (9). The switch may have exterior surface of translucent red plastic through which a light, when lit, may be seen and indicates that the water is at a desired water temperature. Alternatively a large illumination indicator could be used, and may be further coupled with an audio device to indicate the baby bottle's (12) contents reaching the desired temperature.

The desired water temperature may also be set manually with a knob (17) connected to the thermostat. Such knob may be located on the base (11) or the bottle housing (9). The water temperature may be within a range of temperatures from 92 degrees to 100 degrees Fahrenheit, the temperatures at which formula is preferable for feeding to an infant. The temperature can be in any range normally acceptable for infant tolerance. The Ideal temperature of the water should be the normal body temperature, being a temperature average of 98.6 degrees Fahrenheit. Regardless of the actual temperature, it is most important to provide water instantaneously at a uniform temperature, within a range of temperatures acceptable for the baby to consume the formula, so that the water can be mixed with powdered infant formula and fed immediately to the baby.

An alternative embodiment of the heating mechanism utilizes at least one heat lamp projecting visible light and heat onto the baby bottle (12) in the warming zone. Reflectors may be positioned to direct heat and light from lamp(s) such that substantially the entire area of baby bottle (12) is illuminated and heated by the lamp(s). Such lamp(s) operate continuously, providing a steady flow of heat and light to the baby bottle (12). Such lamp(s) may be, in certain preferred embodiments, quartz, or halogen, lamps. Other suitable lamps include non-quartz incandescent lamps, and reflector lamps. The lamp(s), in one embodiment, are 375 watt quartz lamp(s). Other suitable operating parameters of lamps are readily apparent to those skilled in the art. The reflector(s) may be painted or covered with an enamel, or formed of a specular or semi-specular material. One embodiment of the material for reflector is aluminum. The surface of the reflector may be embossed to reduce the possibility of hot spots being created. A thermostat may also be coupled to the invention to insure the deactivation of the heat lamp(s) once the desired temperature is obtained.

An alternative embodiment of the heating mechanism utilizes infrared heating such as quartz tubes. As the temperature of the refractory surface is increased, the maximum IR radiation occurs at shorter wavelengths and has a much higher intensity, with an increasingly greater portion of the radiation occurring nearer the visible range in the electromagnetic spectrum. In one embodiment, the radiation source is a quartz halogen bulb operated at about 375 watts. A reflector preferably is positioned on a side of the bulb opposite the side facing the baby bottle (12). An alternative embodiment of the heating mechanism utilizes an exothermic reaction using an annular wrap around a baby bottle (12) which contains the reagents necessary for the exothermic reaction used for heating the content of the baby bottle (12). In one embodiment, a mass of quicklime grains, the reactivity of which has been moderated by thermal treatment at a temperature of more than about 500 degrees C., is placed in the lower part of the wrap. Above said mass of quicklime, the annular chamber contains a preferably tore-shaped bag containing water in excess with respect to the stoichiometrically necessary amount for the slaking of the quicklime. The wrap is preferably made of a very flexible plastic, such as, for example, polyethylene. The bag preferably contains water under pressure so that, when the bag is pierced by means of a pointed surface, the water is expelled from said bag and flows into the whole mass of quicklime located under said bag, before the hydration reaction of the quicklime heats the baby bottle (12). The outer face of the wrap may be provided with a heat-insulating layer made for example of polystyrene foam.

The heating mechanism may be facilitated through electric heating, ceramic heating, or any other heating method currently known to one skilled in the art. Alternatively, liquid can reside in the bottle housing (9) heated through the use of electrical heating, thus creating a uniform heat source for the baby bottle (12) submerged within.

A radiant heater used may be a flat panel heater, a ceramic heater, or a sheathed heater. Both lamps and radiant heater may be utilized to create the uniform temperature in the baby bottle (12). Any combination of heating methods can be utilized in conjunction with this invention. Alternatively, this invention is not limited by the heating mechanisms disclosed but may utilize any such heating method known to a person skilled in the art. The arm (7) connecting the bottle housing (9) with the dispensing mechanism (5) may be extensible in order to allow baby bottles (12) of different shapes and sizes to be placed in and removed from the bottle housing (9).

In one embodiment, the arm (7) is made up of a vertically extendable and collapsible member and a fixed horizontal member connecting said vertical member to the dispensing mechanism (5).

AS shown in FIGS. 2 and 2a, one embodiment is a telescopic arm (7) which can be made up of an outer member slidably connected to an inner member. The inner member could have notches on its sides to allow a locking mechanism (21) to secure the outer member at specific points relative to the inner member. The outer member could have a slit allowing the locking member to reach the notches located on the inner member. Thus the arm (7) is telescoping with adjustable height.

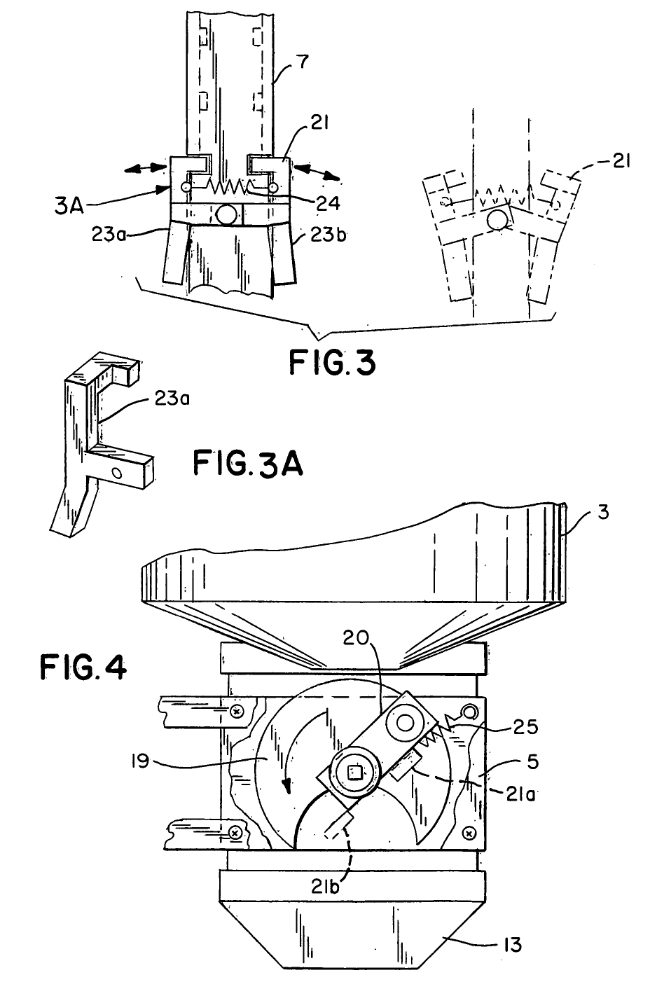

As shown in FIGS. 3 and 3a, the locking mechanism (21) could be made up of a pair of arms (23a and 23b) located on a joint pivot and connected by a spring (24). The locking mechanism (21) could be located on the outer part of the outer member. Each such arm could have an offset protrusion sized to fit within the notches on the inner member. When the user squeezes the locking mechanism's (21) arms, the spring is compressed and the protrusions move apart, thus unlocking the outer member from the inner member. When the locking mechanism's (21) arms are released, the protrusions move closer together by the force of the spring and into a notch on the inner member, thus locking the outer member in place.

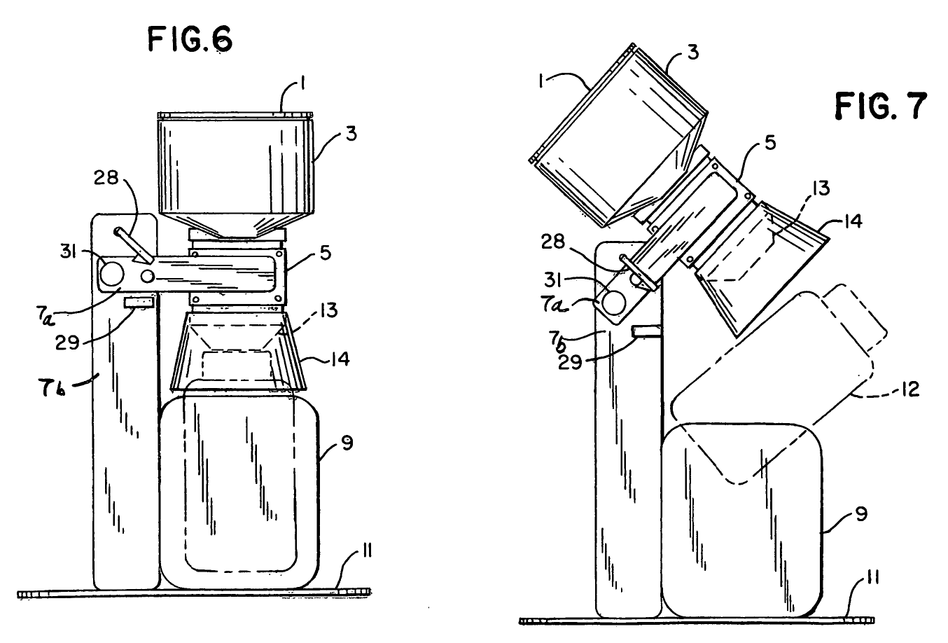

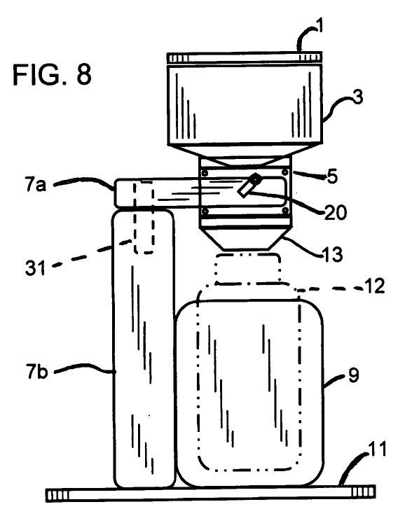

As shown in FIGS. 6, 7 and 8, alternatively, the bottom connecting end of the arm (7b) can be fastened to the bottle housing (9), and the dispensing mechanism (5) pivoted on a joint respective to the bottle housing (9). The arm (7a, 7b) has a screw hole respective of the bottle housing (9) and pivotally connected to a screw hole thereof by a respective screw (31), and therefore the bottom connecting end of the arm (7b) and top connecting end of the arm (7a) connecting the dispensing mechanism (5) form into a toggle joint for permitting the top connecting end of the arm (7a) to be pivoted respective bottle housing (9). Thus, the upper portion of the invention may be able to either pivot vertically as shown in FIG. 6 and FIG. 7 or horizontally as shown in FIG. 8 via the jointed arm.

A locking mechanism (28) could be employed to secure the top connecting end of the arm (7a) at the raised position to facilitate the placement and removal of the baby bottle (12).

A protruding stub (29) could be used to limit the range of rotation of the top connecting end of the arm (7a) so that it does not fall below the horizontal.

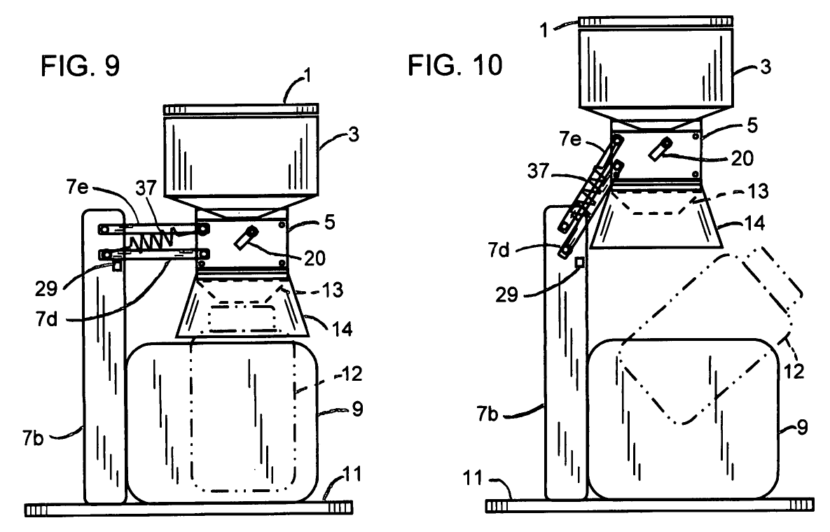

Alternatively, as shown in FIG. 9 and FIG. 10, the arm (7) may be made up of a bottom connecting end (7b) and a co-planer set of hinged arms (7d, 7e). The co-planer arms can take the form of at least two beams total. The preferred embodiment contains two beams allowing removal and placement of the baby bottle (12). On a four beam embodiment, each beam is pivotally connected to the dispensing mechanism (5) on one side, and to a vertical central member on the other side. The vertical central member is connected to a beam which is connected to the bottle housing (9). This allows the movement of the dispensing mechanism (5) with the angular movement of the beams relative to each other. A protruding stub (29) could be used to limit the range of rotation of the co-planer set of hinged arms (7d, 7e) so that they do not fall below the horizontal. Additionally the beams can include springs (37) to add a tensional element to the movement. Additionally the arm (7) may be motorized or spring activated.

The dispensing mechanism (5), formula reservoir (3) and the flange (13) are intended to be easily taken apart for cleaning. Preferably, the components are made of materials which are dishwashing machine compatible. Additionally, the dispensing mechanism (5) can be taken apart to its base components to enable a comprehensive cleaning. This invention is intended to allow convenient and an overall ease of cleaning.

After the water has reached the correct temperature and once the baby formula is dispensed into the baby bottle (12), the user removes the bottle from the bottle housing (9), screws on a nipple and shakes the baby bottle (12) to insure homogenous mixing of the baby formula.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

1. An apparatus for preparing water based baby formula comprising:
A base
a bottle housing providing support for at least one baby bottle removably placed onto such bottle housing;
an arm mounted on the bottle housing with its opposing end attached to a dispenser housing having a dispensing mechanism;
said arm being non-static to allow removal and placement of the bottle onto the bottle housing
said dispensing mechanism comprising at least one formula reservoir to house baby formula to be deposited into the baby bottle, a dispensing member to transport a pre-determined amount of formula from said reservoir into the baby bottle, and a flange to better direct the dispensed formula into the baby bottle;
said baby bottle pre-filled by a user to a predetermined amount of water; and
at least one heating mechanism in thermally conductive adjustable contact with the baby bottle to heat the contents contained therein to a predetermined temperature.

2. An apparatus for preparing water based baby formula as in claim 1 wherein said bottle housing further contains an additional heating mechanism.

3. An apparatus for preparing water based baby formula as in claim 1 wherein the thermal discharge of a heating mechanism is controlled with a thermostat.

4. An apparatus for preparing water based baby formula as in claim 1 wherein said dispensing mechanism comprises a dispensing member having a fixed volume;

5. An apparatus for preparing water based baby formula as in claim 1 wherein said dispensing mechanism comprises a dispensing member having a user adjustable volume.

6. An apparatus for preparing water based baby formula as in claim 1 wherein said formula reservoir is mounted on top of the dispensing mechanism.

7. An apparatus for preparing water based baby formula as in claim 1 wherein said dispensing member is pivotally attached to the dispenser housing and rotates horizontally to facilitate the transportation of formula into the bottle.

8. An apparatus for preparing water based baby formula as in claim 1 wherein said dispensing member is pivotally attached to the dispenser housing and rotates vertically to facilitate the transportation of formula into the bottle.

9. An apparatus for preparing water based baby formula as in claim 1 wherein said dispensing mechanism is spring activated.

10. An apparatus for preparing water based baby formula as in claim 1 wherein said dispensing mechanism requires the user to facilitate the dispensing.

11. An apparatus for preparing water based baby formula as in claim 1 wherein said dispensing mechanism is motor operated.

12. An apparatus for preparing water based baby formula as in claim 1 wherein said dispensing mechanism returns to the fill position after depositing formula into the bottle.

13. An apparatus for preparing water based baby formula as in claim 1 wherein said dispensing mechanism remains in the dispense position after depositing formula into the bottle.

14. An apparatus for preparing water based baby formula as in claim 1 wherein said heating mechanism provides a continuous non-fluctuating thermal emission to keep said baby bottle contents heated to a pre-determined temperature.

15. An apparatus for preparing water based baby formula as in claim 1 wherein said heating mechanism is a flexible heating weave to envelop the circumference of the bottle.

16. An apparatus for preparing water based baby formula as in claim 1 wherein said heating mechanism heats a liquid as an intermediary to facilitate thermal transfer into the bottle.

17. An apparatus for preparing water based baby formula as in claim 1 wherein said heating mechanism utilizes infrared heating.

18. An apparatus for preparing water based baby formula as in claim 1 wherein said heating mechanism is a heat lamp.

19. An apparatus for preparing water based baby formula as in claim 1 wherein said heating mechanism provides flash heating.

20. An apparatus for preparing water based baby formula as in claim 1 wherein said heating mechanism is electrical in nature.

21. An apparatus for preparing water based baby formula as in claim 1 wherein said heating mechanism is facilitated through an exothermic chemical reaction.

22. An apparatus for preparing water based baby formula as in claim 1 wherein said heating mechanism is a flexible ceramic coated electric heating mechanism to envelop the circumference of the bottle.

23. An apparatus for preparing water based baby formula as in claim 1 wherein said heating mechanism is a flexible plastic coated electric heating mechanism to envelop the circumference of the bottle.

24. An apparatus for preparing water based baby formula as in claim 1 wherein said arm is telescopically adjustable.

25. An apparatus for preparing water based baby formula as in claim 1 wherein said arm is pivotally adjustable.

26. An apparatus for preparing water based baby formula as in claim 1 wherein said arm is comprised of multiple, co-planar hinged arms.

27. An apparatus for preparing water based baby formula as in claim 1 wherein said arm can be secured at different positions to facilitate removal and placement of bottle into base.

28. An apparatus for preparing water based baby formula as in claim 1 wherein said arm is spring loaded.

29. An apparatus for preparing water based baby formula as in claim 1 wherein said base is weighted.

30. An apparatus for preparing water based baby formula as in claim 1 wherein said formula reservoir and dispensing mechanism form a breakable seal to keep baby formula fresh.

31. An apparatus for preparing water based baby formula as in claim 1 wherein said formula reservoir includes a removable cover forming a breakable seal therewith.

32. An apparatus for preparing water based baby formula as in claim 1 wherein said arm is electrically operated.

33. An apparatus for preparing water based baby formula comprising:
A base
a bottle housing providing support for at least one baby bottle removably placed onto such bottle housing;
an arm mounted on the bottle housing with its opposing end attached to a dispenser housing having a dispensing mechanism;
said arm being non-static to allow removal and placement of the bottle onto the bottle housing
said dispensing mechanism comprising at least one formula reservoir to house baby formula to be deposited into the baby bottle, a dispensing member to transport a pre-determined amount of formula from said reservoir into the baby bottle, and a flange to better direct the dispensed formula into the baby bottle;
said dispensing member being pivotally attached to the dispenser housing to facilitate the transportation of formula into the bottle said formula reservoir is mounted on top of the dispensing mechanism;
said baby bottle pre-filled by a user to a predetermined amount of water;
at least one heating mechanism in thermally conductive adjustable contact with the baby bottle to heat the contents contained therein to a predetermined temperature;
said heating mechanism is electrical in nature said heating mechanism provides a continuous thermal emission to keep said baby bottle contents heated to a pre-determined temperature the thermal discharge of said heating mechanism is controlled with a thermostat; and
said bottle housing having a heating mechanism.

34. An apparatus for preparing water based baby formula as in claim 33 wherein said dispensing mechanism comprises a dispensing member having a fixed volume;

35. An apparatus for preparing water based baby formula as in claim 33 wherein said dispensing mechanism comprises a dispensing member having a user adjustable volume.

36. An apparatus for preparing water based baby formula as in claim 33 wherein said dispensing member is pivotally attached to the dispenser housing and rotates horizontally to facilitate the transportation of formula into the bottle.

37. An apparatus for preparing water based baby formula as in claim 33 wherein said dispensing member is pivotally attached to the dispenser housing and rotates vertically to facilitate the transportation of formula into the bottle.

38. An apparatus for preparing water based baby formula as in claim 33 wherein said dispensing mechanism is spring activated.

39. An apparatus for preparing water based baby formula as in claim 33 wherein said dispensing mechanism requires the user to facilitate the dispensing.

40. An apparatus for preparing water based baby formula as in claim 33 wherein said dispensing mechanism is motor operated.

41. An apparatus for preparing water based baby formula as in claim 33 wherein said heating mechanism is a flexible heating weave to envelop all or part of the circumference of the bottle.

42. An apparatus for preparing water based baby formula as in claim 33 wherein said arm is telescopically adjustable.

43. An apparatus for preparing water based baby formula as in claim 33 wherein said arm is pivotally adjustable.

44. An apparatus for preparing water based baby formula as in claim 33 wherein said arm can be secured at different positions to facilitate removal and placement of bottle into base.

45. An apparatus for preparing water based baby formula as in claim 33 wherein said arm is comprised of multiple, co-planar hinged arms.

46. An apparatus for preparing water based baby formula as in claim 33 wherein said arm is spring loaded.

47. An apparatus for preparing water based baby formula as in claim 33 wherein said heating mechanism is a flexible plastic coated electric heating mechanism to envelop all or part of the circumference of the bottle.

48. An apparatus for preparing water based baby formula as in claim 33 wherein said heating mechanism is a flexible ceramic coated electric heating mechanism to envelop all or part of the circumference of the bottle.

49. An apparatus for preparing water based baby formula comprising:
A base
a bottle housing providing support for at least one baby bottle removably placed on such bottle housing;
a telescopically adjustable arm mounted on the bottle housing with its opposing end attached to a dispenser housing having a dispensing mechanism;
said arm being non-static to allow removal and placement of the bottle onto the bottle housing;
said arm can be secured at different positions to facilitate removal and placement of bottle into bottle housing;
said dispensing mechanism comprising at least one formula reservoir to house baby formula to be deposited into the baby bottle and a dispensing member pivotally attached to said dispenser housing to transport a pre-determined amount of formula from said reservoir into the baby bottle;
said dispensing member rotates vertically.
said formula reservoir is mounted on top of the dispensing mechanism;
said baby bottle pre-filled by a user to a predetermined amount of water;
at least one heating mechanism in thermally conductive adjustable contact with the baby bottle to heat the contents contained therein to a predetermined temperature;
said heating mechanism is electrical in nature;
said heating mechanisms provides a continuous thermal emission to keep said baby bottle contents heated to a pre-determined temperature;
the thermal discharge of said heating mechanism is controlled with a thermostat; and said bottle housing having a heating mechanism.

50. An apparatus for preparing water based baby formula as in claim 49 wherein said dispensing mechanism comprises a dispensing member having a fixed volume;

51. An apparatus for preparing water based baby formula as in claim 49 wherein said dispensing mechanism comprises a dispensing member having a user adjustable volume.

52. An apparatus for preparing water based baby formula as in claim 49 wherein said dispensing member is pivotally attached to the dispenser housing and rotates horizontally to facilitate the transportation of formula into the bottle.

53. An apparatus for preparing water based baby formula as in claim 49 wherein said dispensing member is pivotally attached to the dispenser housing and rotates vertically to facilitate the transportation of formula into the bottle.

54. An apparatus for preparing water based baby formula as in claim 49 wherein said dispensing mechanism is spring activated.

55. An apparatus for preparing water based baby formula as in claim 49 wherein said dispensing mechanism requires the user to facilitate the dispensing.

56. An apparatus for preparing water based baby formula as in claim 49 wherein said dispensing mechanism is motor operated.

57. An apparatus for preparing water based baby formula as in claim 49 wherein said heating mechanism is a flexible heating weave to envelop all or part of the circumference of the bottle.

58. An apparatus for preparing water based baby formula as in claim 49 wherein said heating mechanism is a flexible plastic coated electric heating mechanism to envelop all or part of the circumference of the bottle.

59. An apparatus for preparing water based baby formula as in claim 49 wherein said heating mechanism is a flexible ceramic coated electric heating mechanism to envelop all or part of the circumference of the bottle.
